(19) United States
(12) Patent Application Publication
(10) Pub. No.: US 2007/0046026 A1
(43) Pub. Date: Mar. 1, 2007

(54) Tube-to-tube connection

(76) Inventors: Billy P. Wells, Hillsdale, MI (US); Thomas R. Fellabaum, Coldwater, MI (US)

Correspondence Address: VAN OPHEM & VANOPHEM, PC;REMY J VANOPHEM, PC, 51543 VAN DYKE, SHELBY TOWNSHIP, MI, 48316-4447, US

(21) Appl. No.: 11/216,508

(22) Filed: Aug. 31, 2005

(51) Int. Cl. F16L 13/14

(52) U.S. Cl. 285/382; 285/347; 285/334.5; 29/511

(57) ABSTRACT

A sealed, tube-to-tube connection is made up of a first tubing member, a second tubing member and an elastomeric O-ring, the connection being free of any separate member to maintain the first tubing member, the second tubing member and the elastic O-ring in assembled relationship. The first tubing member is provided with an outwardly projecting annular bead at a location inwardly of a free or distal end of the first tubing member, and an outer diameter pilot portion of reduced diameter between the annular bead and the free or distal end of the first tubing member. The second tubing member is provided with an enlarged diameter end portion, a first enlarged portion axially inwardly of the enlarged diameter end portion and an annular shoulder joining the first enlarged diameter portion and the enlarged diameter portion. The pilot portion of the first tubing member is inserted into the second tubing member, after mounting the elastomeric O-ring over the pilot section of the first tubing member, until the O-ring is compressed around its circumference between one side surface of the annular bead of the first tubing member and the annular shoulder of the second tubing member. At this time, the pilot section of the first tubing joint section will be snuggly surrounded by the first enlarged diameter portion of the second tubing member to accurately axially align and seal the first tubing member to the second tubing member. Thereafter, an outermost terminal portion of the second tubing member is rolled inwardly to engage an opposed side surface of the annular bead of the first tubing member to secure the first tubing member, the second tubing member and the O-ring in assembled relationship with one another.

### CROSS REFERENCE TO RELATED APPLICATION

Not Applicable

### FEDERALLY SPONSORED RESEARCH OR DEVELOPMENT

Not Applicable

### REFERENCE TO MICROFICHE APPENDIX

Not Applicable

### BACKGROUND OF THE INVENTION

1. Field of the Invention

This invention relates to an in-line tube-to-tube connection that is made up of separate tubing members that are sealingly joined to one another. More particularly, this invention relates to a connection of the aforesaid character that is especially useful in joining aluminum tubing members in an automotive air conditioning system.

2. Description of the Prior Art

U.S. Pat. No. 4,693,502 (Oetiker) describes various embodiments of a sealed, in-line joint that is made up of separate pipe or tubing members. The embodiment of FIG. 7, which appears to be the simplest in construction, requires three metallic members, the pipe or tube members 1 and 2 and a clamping member 9, in addition to a gasket 118. Other embodiments, such as that of FIG. 8, require a fourth metallic member, namely the pipe insert section 14. The requirement for a third metallic member, in addition to the tube or joint members themselves and a suitable gasket, adds to the cost of the joint and the difficulty in assembling it, and these problems are compounded in joints that require a fourth metallic member. U.S. Pat. No. 5,454,604 (Yahagi et al.) also discloses an in-line joint construction for a pipe that requires a third metallic piece, namely the clamp member 8, in addition to the pipe sections themselves and a suitable gasket.

### BRIEF DESCRIPTION OF THE INVENTION

The aforesaid and other problems associated with tube-to-tube connections for tubing sections are avoided by the construction of the present invention in which no more than the tubing sections themselves, with a suitable gasket when necessary, are required to form a suitable leak-resistant connection. According to the present invention, a first tubing member is provided with a suitable end treatment to form an outwardly projecting annular bead at a location somewhat inwardly of a free end of the first tubing member. An elastomeric member or equivalent O-ring is positioned on the first tubing member between the bead and the free end of the first tubing member during the assembly of the joint. Preferably, the portion of the first tubing member that extends from the annular bead to the free end of the first tubing member is reduced in its O.D. for purposes that will hereinafter be described more fully.

A second tubing member is provided with a suitable end treatment to form a two tier enlarged I.D. portion at its free or distal end. The first enlarged I.D. portion is inwardly of the free or distal end of the second tubing member adjacent a normal I.D. section 20a. A further enlarged I.D. section is located between the free or distal end of the second tubing member and the first enlarged I.D. portion. The first enlarged I.D. section being joined to the second enlarged I.D. section by an annular wall that tapers outwards toward the free end of the second tubing member. To assemble the joint from the components as heretofore described, the O-ring is inserted over the reduced O.D. portion of the first tubing member, the reduced outer diameter portion of the first tubing member is inserted into the free end of the second tubing member until the annular wall of the second tubing member compresses the O-ring against the annular bead of the first tubing member, which causes the reduced O.D. portion of the first tubing section to be received into the first enlarged I.D. portion of the second tubing member to accurately axially align and seal the first and second tubing members with respect to one another. At this point, the free or distal end of the further enlarged I.D. of the second tubing member is roll formed inwardly to engage an opposed side of the annular bead of the first tubing member to securely compress and maintain the O-ring between the annular bead of the first tubing member and the annular wall of the second tubing member thereby sealing the tube-to-tube connection.

Accordingly, it is an object of the present invention to provide an in-line tube-to-tube connection that is simple in construction and effective in permitting leak-free flow of fluid from a first tubing member to a second tubing member.

It is a further object of the present invention to provide a tube-to-tube connection of different types and sizes via a leak-proof mechanical locking mechanism.

It is yet a further object of the present invention to provide a tube-to-tube connection.

More particurlarly, it is an object of the present invention to provide a tube-to-tube connection of the aforesaid character that is well-suited for use in an automotive air conditioning system.

For a further understanding of the present invention and the objects thereof, attention is directed to the drawing and the following brief description thereof, to the detailed description of the invention and to the appended claims.

### BRIEF DESCRIPTION OF THE DRAWING

FIG. 1 is an elevational view, in cross-section, of a first tubing member of a tube-to-tube connection according to a preferred embodiment of the present invention, an O-ring being shown on the first tubing member itself at a location where it will be placed during assembly of the tube-to-tube connection;

FIG. 2 is an elevational view, in cross-section, of a second tubing member of a tube-to-tube connection according to the preferred embodiment of the present invention; and

FIG. 3 is an elevational view, in cross-section, of the tubing members of FIG. 1 and of FIG. 2 in complete assembled relationship.

### DETAILED DESCRIPTION OF THE INVENTION

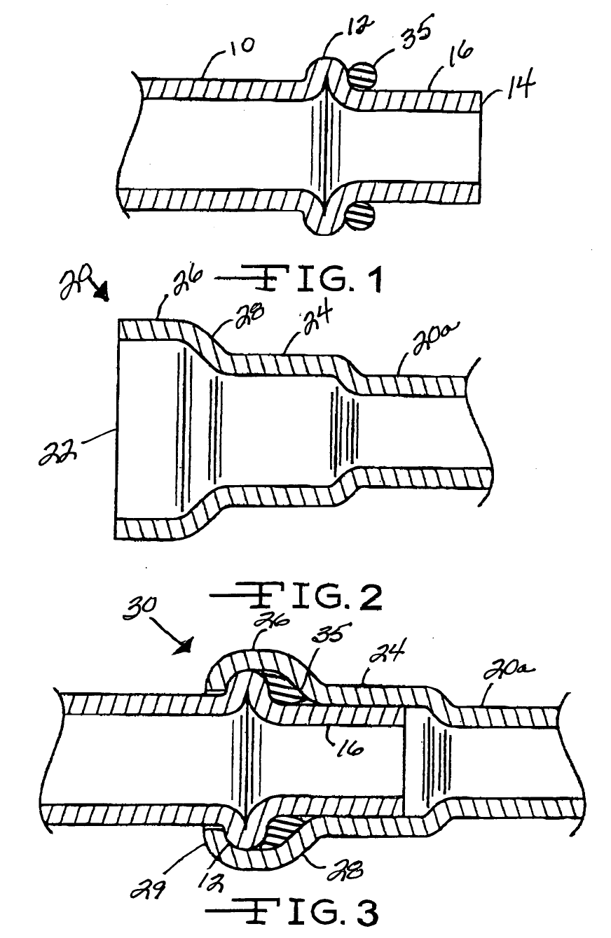

A tube-to-tube connection according to the present invention includes a first tubing member 10, as shown in FIGS. 1 and 3, a second tubing member 20, as shown in FIGS. 2 and 3, and an annular seal 35, such as an elastomeric O-ring, which is also shown in FIGS. 1 and 3. Each of the tubing members 10 and 20 will usually be circular in transverse cross-section.

The first tubing member 10 is manufactured with an end treatment to provide it with an outwardly projecting annular bead 12 somewhat inwardly of its free or distal end 14, and preferably with a slightly reduced outer diameter pilot portion 16 extending from the outwardly projecting annular bead 12 to the distal end 14. The second tubing member 20 is manufactured with an end treatment to provide it with a two tier enlarged inside diameter free or distal end portion 26. A first enlarged I.D. portion 24 is inwardly of the distal end 22 adjacent the normal I.D. of the second tubing member 20. A second enlarged I.D. portion 26 is located between the free or distal end 22 and the first enlarged I.D. portion 24 of the second tubing member 20. The first enlarged I.D. portion 24 being joined to the second enlarged I.D. portion 26 by an annular shoulder 28. The annular shoulder 28 tapering outwardly from the first enlarged portion 24 toward the second enlarged diameter portion 26. For illustrative purposes, the assembled tube-to-tube connection of FIG. 3, which is generally indicated by reference numeral 30, may be considered to have particular utility in an automotive air conditioning system, in which case the first tubing member 10 and the second tubing member 20 may be considered to have been formed in conventional manners from a suitable aluminum alloy.

To assemble the tube-to-tube connection 30 from its components, the free or distal end 14 of the first tubing member 10, after installing the O-ring 35 over the pilot portion 16 of the first tubing member 10 to nest against a terminal surface of the annular bead 12, is inserted into the free or distal end portion of the second tubing member 20 until the pilot portion 16 of the first tubing member 10 fits snuggly within the first enlarged portion 24 of the second tubing member 20. This will compress the O-ring 35 between the annular bead 12 of the first tubing member 10 and the annular shoulder 28 of the second tubing member 20, to form a suitable fluid seal between the first tubing member 10 and the second tubing member 20. The overlapping relationship between the first enlarged portion 24 of the second tubing member 20 and the pilot section 16 of the first tubing member 10 will serve to accurately axially align the first tubing member 10 and the second tubing member 20 with respect to one another. Further, the reduced diameter pilot portion 16 of the first tubing member 10 will serve to minimize the magnitude of flow diameters within the tube-to-tube connection 30 for minimal resistance flow through the tube-to-tube connection 30. Although the I.D. of the reduced outer diameter pilot portion 16 is somewhat reduced from the I.D. of the first tubing member 20, it is no smaller than the I.D. of the normal I.D. 20a of the second tubing member 20. Therefore, there is not loss of flow across the connection due to resizing of the tubing members 10, 20. When the assembly of the first tubing member 10, the second tubing member 20 and the O-ring 35, as thus far described, has been completed, an annular terminal portion 29 of the enlarged diameter portion 26 of the second tubular member 20 is rolled inwardly to engage an opposed side of the annular bead 12 of the first tubing member 10, to secure the first tubing member 10, the second tubing member 20 and the O-ring 35 in a completed tube-to-tube connection 30, as shown in FIG. 3, with the O-ring 35 in compression around its circumference to seal the connection.

Although the best mode contemplated by the inventors for carrying out the present invention as of the filing date hereof has been shown and described herein, it will be appreciated by those skilled in the art that suitable modifications, variations and equivalents can be made without departing from the scope of the invention, such scope limited solely by the terms of the following claims and the legal equivalents thereof.

What is claimed is:

1. A tube-to-tube connection comprising, in combination:
a first tubing member, having a free end and an annular radially outwardly projecting bead at a location axially spaced from said free end;
an annular gasket positioned over the first tubing member at a location between said free end and said annular bead; and
a second tubing member having an enlarged diameter portion at its free end, said enlarged diameter portion being spaced from an interior portion of the second by an annular shoulder, the enlarged diameter portion receiving a portion of the first tubing member between the annular bead and the free end of the first tubing member to compress the annular gasket around its circumference between the annular bead and the annular shoulder, an outermost free end portion of the second tubing member being rolled over to engage the annular bead at a location opposed to a location of contact between the annular bead and the annular gasket to maintain the annular gasket in compression around its circumference to create a seal.

2. A tube-to-tube connection according to claim 1 wherein:
said first tubing member further comprises a reduced diameter pilot section between said annular bead and said free end; and
said second tubing member further comprises a first enlarged diameter portion inwardly of said annular shoulder,
said first enlarged portion of said second tubing member snuggly receiving said pilot section of said first tubing member to accurately axially align said first tubing member and said second tubing member.

3. A tube-to-tube connection according to claim 2 wherein:
said tubing member is free of any separate element to maintain said first tubing member and said second tubing member in position relative to one another to maintain said annular gasket in compression around its circumference.

4. A tube-to-tube connection according to claim 3 that is useful in an automotive air conditioning system, wherein each of said first tubing member and said second tubing member is formed of a suitable aluminum alloy.

5. A tube-to-tube connection according to claim 4 wherein:
said annular gasket is an elastomeric O-ring.

6. A method of forming a sealed tube-to-tube connection comprising:
providing a first tubing member with a free end and an annular radially outwardly projecting annular bead at a location axially inwardly of the free end;
providing an annular gasket;
providing a second tubing member with an enlarged diameter portion at a free end and an annular shoulder axially inwardly of the enlarged diameter portion;
inserting the annular gasket over the first tubing member at a location between the outwardly projecting band and the free end of the first tubing member; and
inserting the first tubing member into the second tubing member until the annular gasket is compressed around its circumference between the annular bead of the first tubing member and the annular shoulder of the second tubing member.

7. The method according to claim 6 and then further comprising:
rolling in an outermost free end portion of the enlarged diameter portion of the second tubing member to engage a side of the annular bead of the first tubing member that is opposed to the free end of the first tubing member, to thereby securely axially position the first tubing member and the second tubing member relative to one another with the annular gasket in compression around its circumference.

8. A method according to claim 7 and further comprising:
providing the first tubing member with a reduced diameter portion between the annular bead and the free end;
providing the second tubing member with a partly expanded diameter portion axially inwardly of the annular shoulder; and
inserting the first tubing member into the second tubing member until the reduced diameter portion of the first tubing member is snuggly received within the partly expanded portion of the second tubing member to accurately axially align the first tubing member and the second tubing member.

9. The method according to claim 8 wherein:
each of the first tubing member and the second tubing member is formed of an aluminum alloy; and then:
using the sealed tube-to-tube connection in an automotive air conditioning system.
